(19) United States
(12) Patent Application Publication
(10) Pub. No.: US 2023/0119218 A1
(43) Pub. Date: Apr. 20, 2023

(54) UPPER LIMB REHABILITATION DEVICE

(71) Applicant: YEUNG KI KIM, Daegu (KR)

(72) Inventor: KYEONGMIN KIM, Fullerton (CA)

(73) Assignee: YEUNG KI KIM, Daegu (KR)

(21) Appl. No.: 17/506,241

(22) Filed: Oct. 20, 2021

(51) Int. Cl. A61H 1/02

(52) U.S. Cl. CPC A61H 1/0285; A61H 2201/1638; A61H 2201/1671; A61H 2201/1664

(57) ABSTRACT

Disclosed is an upper limb rehabilitation device. The device includes a grip portion provided to be held by a user's hand, and a grip-portion opening portion operating the grip portion to open or close the grip portion. The device further includes a pressing portion provided to be spaced apart from the grip portion. The pressing portion causes the user's hand positioned between the grip portion and the pressing portion to come into close contact with the grip portion. The device further includes a prop portion on which the grip portion and the grip-portion opening portion are seated, and an arm support portion configured to support a user's arm. The prop portion is connected at a first side thereof to the arm support portion, and the first side of the prop portion may be rotatably connected to the arm support portion.

### BACKGROUND

The present disclosure relates to an upper limb rehabilitation device and, more particularly, to an upper limb rehabilitation device, which opens and fixes the finger, hand, or the like, or rotates and fixes the arm or the like, thus stretching the atrophied muscle and thereby helping to relieve or prevent muscular stiffness.

Generally, damage to a central nervous system, such as cerebral stroke or brain damage, causes motor disturbance accompanied by paralysis, sensory defects, a lack of perceptive abilities, etc. In particular, the cerebral stroke in which cerebral blood vessels are blocked or ruptured to lead to the circulatory disturbances of the cerebral blood vessels may cause symptoms such as altered consciousness, paralysis of the upper and lower limbs of one side, facial paralysis, etc.

The number of patients with cerebral stroke is increasing throughout the world. Many stroke patients experience the paralysis of the upper and lower limbs of one side, i.e., hemiplegia. In order to rehabilitate patients with hemiplegia due to cerebral stroke, a rehabilitation treatment process is needed to continuously exercise a body region that is lost or deteriorated in motor ability due to paralysis, thus activating a motor ability.

In order to rehabilitate patients with hemiplegia due to cerebral stroke, a passive exercise treatment in which a rehabilitation therapist performs the exercise treatment is widely used. However, since the rehabilitation treatment should be continued for a long period of time and requires a large amount of exercise, a heavy burden is imposed on the rehabilitation therapist.

Generally, the rehabilitation treatment for a patient with hemiplegia by the rehabilitation therapist is performed by repeating the process of pulling a paralyzed muscle for a certain period of time and then returning the muscle to its original position. In the rehabilitation treatment process, the rehabilitation therapist should perform a treatment process together with a patient, so it is difficult to perform the rehabilitation treatment for many patients. Further, if the number of rehabilitation therapists is insufficient, a problem may occur where it takes a long time to treat the patient.

It is necessary to develop technology which allows a rehabilitation therapist to efficiently perform the rehabilitation process for a large number of patients. This technology is being developed.

As technology related to the rehabilitation device, especially the upper limb rehabilitation device, Korean Patent KR 10-1048555 entitled “Passive sports machine for hands” has been proposed. This is a technical configuration for pulling a patient's palm, and includes a holding means on which the patient's palm is held, and a pulling line for pulling the holding means. The related art is advantageous in that it may be used not by a rehabilitation therapist but by a patient or a patient caregiver, so the rehabilitation therapist can efficiently manage rehabilitation for many patients. However, this is problematic in that a considerably large force is required when a patient or a patient caregiver pulls the pulling line so as to pull the patient's palm, and the pulling process is performed by the patient or the caregiver, so it is difficult to precisely stretch a target that is to be stretched, i.e. the palm.

### SUMMARY

The present disclosure provides an upper limb rehabilitation device, in which not a rehabilitation therapist but a patient or a patient caregiver himself or herself can precisely stretch a paralyzed hand region, and the rehabilitation therapist can efficiently manage rehabilitation for a large number of patients.

In an aspect, an upper limb rehabilitation device is provided. The upper limb rehabilitation device includes a grip portion provided to be held by a user's hand, and a grip-portion opening portion operating the grip portion to open or close the grip portion.

The upper limb rehabilitation device may further include a pressing portion provided to be spaced apart from the grip portion. The pressing portion may cause the user's hand positioned between the grip portion and the pressing portion to come into close contact with the grip portion.

The grip portion may include a first grip portion contacting some of the user's fingers, and a second grip portion contacting other fingers of the user. The grip-portion opening portion may move the first grip portion and the second grip portion relative to each other to stretch some of the user's fingers or other fingers. A first side of each of the first grip portion and the second grip portion may be provided to face the user's palm. A second side of each of the first grip portion and the second grip portion may be provided to face an outside of the user's palm. The grip-portion opening portion may adjust a distance between the first grip portion and the second grip portion such that a distance between the second side of the first grip portion and the second side of the second grip portion is larger than a distance between the first side of the first grip portion and the first side of the second grip portion.

According to an embodiment, some of the user's fingers may contact an outer surface of the first grip portion, while other fingers may contact an outer surface of the second grip portion. The grip-portion opening portion may include a rotating portion that is rotatable, a support portion configured to support the rotating portion such that it is rotatable at a fixed position, and a moving portion configured to move rectilinearly above the rotating portion when the rotating portion rotates. At least any one of the first grip portion and the second grip portion may be connected to the support portion and the moving portion. At least any one of the first grip portion and the second grip portion may be opened or closed by the rectilinear movement of the moving portion.

According to another embodiment, some of the user's fingers may contact an outer surface of the first grip portion, while other fingers may contact an outer surface of the second grip portion. The grip-portion opening portion may include a rotating portion that has a thread on an outer surface thereof and is rotatable, a support portion fixedly supporting the rotating portion so that the rotating portion is rotatable, a moving portion having a through hole through which the rotating portion passes, and coupled in a thread fastening method to the rotating portion, a first connecting portion connecting an inner surface of the first grip portion and the support portion, and rotatably provided on the support portion, a second connecting portion connecting the inner surface of the first grip portion and the moving portion, and provided to be rotatable with the inner surface of the first grip portion and the moving portion, respectively, a third connecting portion connecting an inner surface of the second grip portion and the support portion, and rotatably provided on the support portion, and a fourth connecting portion connecting the inner surface of the second grip portion and the moving portion, and provided to be rotatable with the inner surface of the second grip portion and the moving portion, respectively.

The upper limb rehabilitation device may further include a prop portion on which the grip portion and the grip-portion opening portion are seated, and an arm support portion configured to support a user's arm. The prop portion may be connected at a first side thereof to the arm support portion, and the first side of the prop portion may be rotatably connected to the arm support portion. The upper limb rehabilitation device may further include a fixing portion configured to fix the prop portion that has rotated relative to the arm support portion.

The fixing portion may include a fixing plate provided under the prop portion and secured at a first side thereof to the arm support portion, and an arm-rotation-angle maintaining portion secured to the fixing plate to prevent a movement of the prop portion that has rotated relative to the arm support portion. A second side of the fixing plate may be provided in a shape of an arc, and a plurality of depressions may be provided along a circumference of the second side of the fixing plate. The arm-rotation-angle maintaining portion may be provided on a second side of the prop portion. In this case, the arm-rotation-angle maintaining portion may be fastened to any one of the plurality of depressions to fix a rotating position of the prop portion that has rotated relative to the arm support portion. The grip portion may include a first grip portion contacting some of the user's fingers, and a second grip portion contacting other fingers of the user. The grip-portion opening portion may move the first grip portion and the second grip portion relative to each other to stretch some of the user's fingers or other fingers.

The present disclosure includes the grip portion that may be held by the hand of a user, i.e., a patient, and the grip-portion opening portion that may open or close the grip portion. The user, the user's caregiver, or the rehabilitation therapist may stretch the user's hand or the user's fingers, which hold the grip portion, by operating the grip-portion opening portion, may adjust the degree of opening or closing the grip portion through the grip-portion opening portion, and then may fix the grip portion, thus allowing the user's hand or the user's fingers to be precisely stretched.

Further, the present disclosure allows the user's hand or the user's fingers, positioned between the grip portion and the pressing portion through the pressing portion provided to be spaced apart from the grip portion, to stably come into close contact with the grip portion, thus allowing the user's hand or the user's fingers to be stably stretched while the grip portion is opened by the grip-portion opening portion.

Furthermore, the present disclosure may include the prop portion on which the grip portion and the grip-portion opening portion are seated, and the arm support portion to which the prop portion is rotatably connected and which supports the user's arm. The user may hold the grip portion with the user's hand in a state where the user's arm is supported on the arm support portion. Thereafter, the user may rotate the prop portion relative to the arm support portion, thus enabling the user's arm and the user's wrist to be stretched. In this case, the present disclosure may further include the fixing portion for fixing the prop portion that has rotated relative to the arm support portion, thus fixing the prop portion that has rotated relative to the arm support portion, and thereby allowing the user's arm and the user's wrist to be precisely stretched.

In a state where the user's arm is supported by the arm support portion, the user's hand holds the grip portion, and the user's arm is rotated through the rotation of the prop portion relative to the arm support portion, the grip portion may be opened through the grip-portion opening portion. Thereby, the present disclosure may simultaneously stretch the user's arm, the user's wrist, the user's hand, and the user's fingers.

The effects of the present invention are not limited to the above-described effects, and it should be understood to cover all effects that can be inferred from the configuration of the invention described in the detailed description or claims of the present invention.

The foregoing provides only an optional concept in a simplified form for components that will be described below in detail. It is not intended to restrict key features or essential features of the claims, or to limit the scope of the claims.

### BRIEF DESCRIPTION OF THE DRAWINGS

FIG. 1 is a diagram illustrating an upper limb rehabilitation device according to the present disclosure.

FIG. 2 is a diagram illustrating a state in which a user uses the upper limb rehabilitation device according to the present disclosure.

FIG. 3 is a diagram illustrating the operation of a grip portion, a grip-portion opening portion, and a pressing portion of the upper limb rehabilitation device according to the present disclosure.

FIG. 4 is a diagram illustrating an example of the grip-portion opening portion of the upper limb rehabilitation device according to the present disclosure.

FIG. 5 is a diagram illustrating a prop portion and an arm support portion of the upper limb rehabilitation device according to the present disclosure.

FIG. 6 is a diagram illustrating a fixing portion of the upper limb rehabilitation device according to the present disclosure.

FIG. 7 is a diagram illustrating the operation of the grip portion, the grip-portion opening portion, the prop portion, and the arm support portion of the upper limb rehabilitation device according to the present disclosure.

### DETAILED DESCRIPTION

Hereinafter, embodiments of the present disclosure will be described in detail with reference to the accompanying drawings. Unless otherwise specified herein, the same reference numerals are used throughout the drawings to designate the same or similar components. It is to be understood that the present description is not intended to limit the present disclosure to those exemplary embodiments, and the present disclosure is intended to cover not only the exemplary embodiments, but also various alternatives, modifications, equivalents, and other embodiments that fall within the spirit and scope of the present disclosure. Those skilled in the art may variously arrange, construct, combine, and design components of the present disclosure, i.e., components that are generally described herein and illustrated in the drawings. It is to be readily appreciated that they form a part of the present disclosure. Furthermore, the width, length, thickness, or shape of components shown in the drawings may be exaggerated for the clarity of description.

It will be understood that when a component is referred to as being “provided” on another component, it can be directly provided on the other component or intervening components may be present therebetween.

It will be understood that when a component is referred to as being “connected” to another component, it can be directly connected to the other component or intervening components may be present therebetween.

It will be understood that when a component is referred to as being “fixed” to another component, it can be directly fixed to the other component or intervening components may be present therebetween.

Specific structural or functional descriptions of the present disclosure are only for description of the embodiments of the present disclosure. The descriptions should not be construed as being limited to the embodiments described in the specification. Since the present disclosure may be embodied in many different forms, it should be understood that the scope of the disclosed technology covers equivalents capable of realizing the technical idea.

In the present disclosure, the singular forms are intended to include the plural forms as well, unless the context clearly indicates otherwise. It is to be further understood that the terms “comprise”, “include”, “have”, etc. when used in this specification, specify the presence of stated features, integers, steps, operations, elements, components, and/or combinations thereof but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

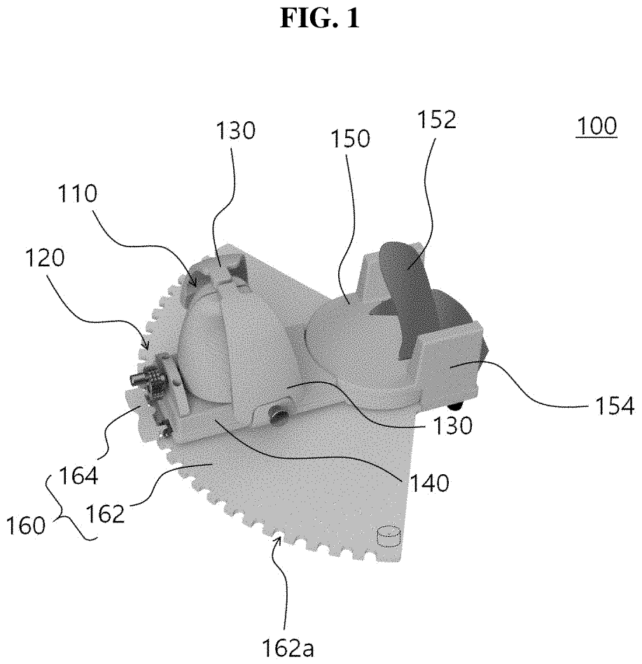

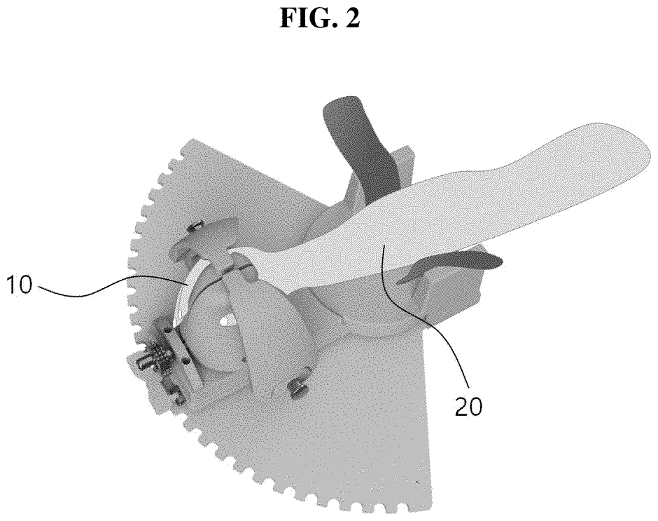

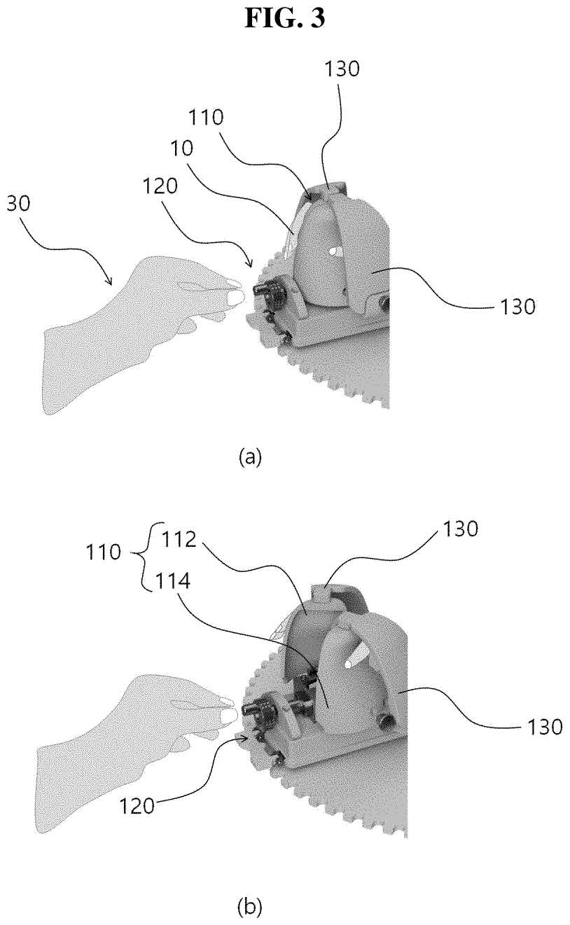

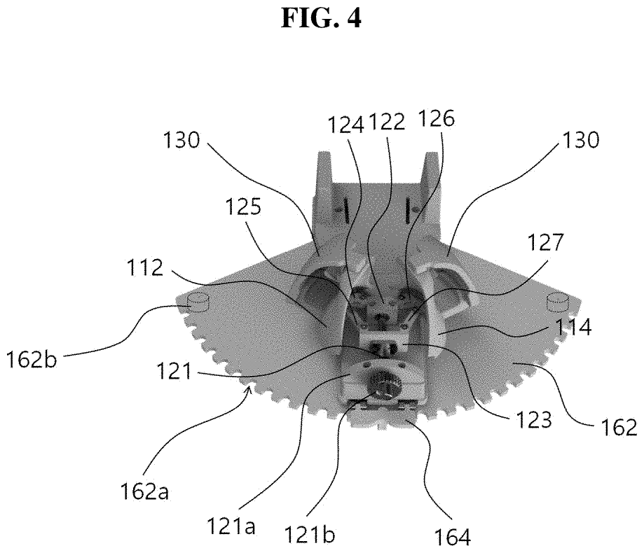

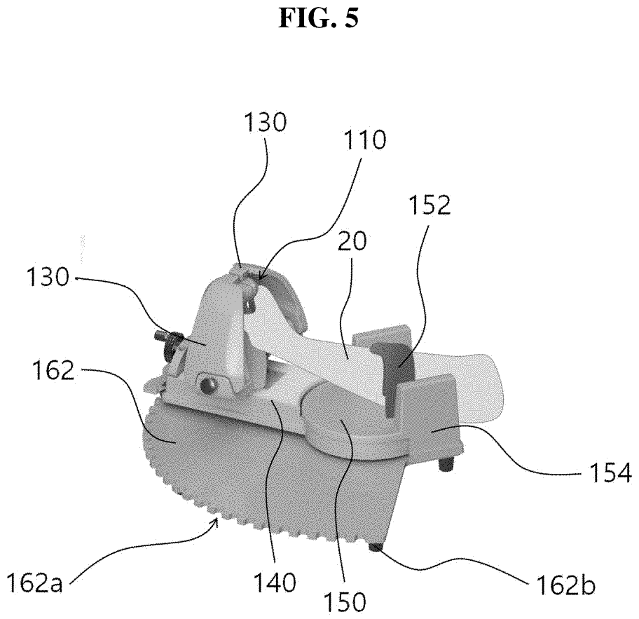

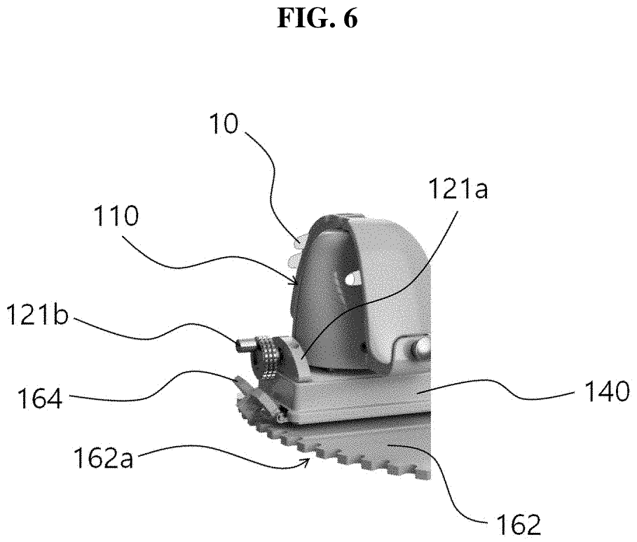

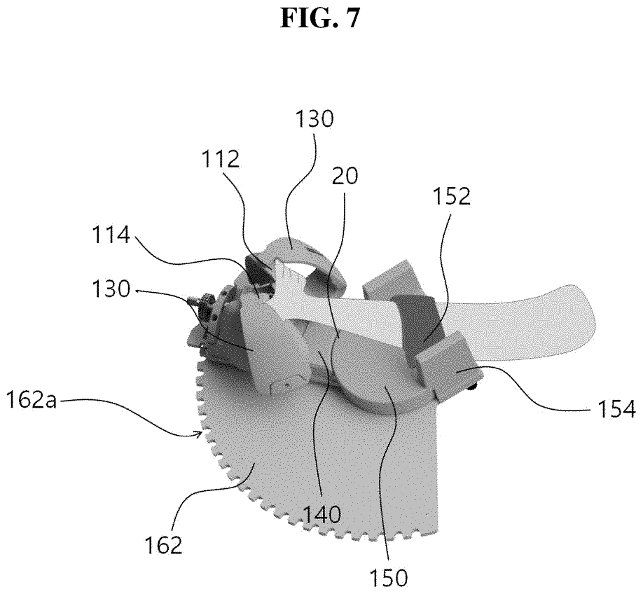

FIG. 1 is a diagram illustrating an upper limb rehabilitation device according to the present disclosure. FIG. 2 is a diagram illustrating a state in which a user uses the upper limb rehabilitation device according to the present disclosure. FIG. 3 is a diagram illustrating the operation of a grip portion, a grip-portion opening portion, and a pressing portion of the upper limb rehabilitation device according to the present disclosure. FIG. 3(a) is a diagram illustrating a state in which a user holds the grip portion with his or her hand, and FIG. 3(b) is a diagram illustrating a state in which a user operates the grip portion through the grip-portion opening portion to open the grip portion. FIG. 4 is a diagram illustrating an example of the grip-portion opening portion of the upper limb rehabilitation device according to the present disclosure. FIG. 5 is a diagram illustrating a prop portion and an arm support portion of the upper limb rehabilitation device according to the present disclosure. FIG. 6 is a diagram illustrating a fixing portion of the upper limb rehabilitation device according to the present disclosure. FIG. 7 is a diagram illustrating the operation of the grip portion, the grip-portion opening portion, the prop portion, and the arm support portion of the upper limb rehabilitation device according to the present disclosure.

Hereinafter, the upper limb rehabilitation device according to the present disclosure will be described with reference to the accompanying drawings.

Referring to the drawings, the upper limb rehabilitation device 100 includes a grip portion 110 and a grip-portion opening portion 120. In some other embodiments, the upper limb rehabilitation device 100 may optionally include a pressing portion 130, a prop portion 140, an arm support portion 150, and a fixing portion 160.

The grip portion 110 is provided to be held by a user's hand. A material of the grip portion 110 is not limited as long as it may perform a function that will be described later.

The grip-portion opening portion 120 operates the grip portion 110 to open or close the grip portion 110. To be more specific, an operator 30 opens the grip portion 110 through the grip-portion opening portion 120 in a state where a user's hand 10 holds the grip portion 110, thus opening the user's hand 10 to a level required for rehabilitation. Thereby, the upper limb rehabilitation device 100 according to the present disclosure may stretch the user's hand 10 or the user's fingers. The operator 30 may be a user himself, a user's caregiver, or a rehabilitation therapist. The grip portion 110 may be opened or closed through the grip-portion opening portion 120 to adjust the opening degree of the grip portion 110 depending on the stiffness of the user's hand 10 or the user's fingers, and thereby allow the user's hand 10 or the user's fingers to be stretched according to the user's rehabilitation level.

The opening degree of the grip portion 110 that is opened according to the user's rehabilitation level through the grip-portion opening portion 120 may be fixed. Thereby, the upper limb rehabilitation device 100 according to the present disclosure may stretch the user's hand 10 or the user's fingers to a predetermined level.

For example, the grip portion 110 may be opened by the grip-portion opening portion 120 such that a part of the grip portion 110 positioned towards the user's palm is opened or a part of the grip portion 110 positioned towards the outside of the user's palm is opened.

The pressing portion 130 may be provided to be spaced apart from the grip portion 110. The material of the pressing portion 130 is not limited as long as it may perform a function that will be described later.

The pressing portion 130 may cause the user's hand 10 or the user's fingers positioned between the grip portion 110 and the pressing portion 130 to be in close contact with the grip portion 110. To be more specific, when a user who suffers from the symptom of stiffness in at least some of the user's fingers (hereinafter referred to as a stiff finger) holds the grip portion 110, the stiff finger protrudes towards the back of the hand. In this case, while the grip portion 110 is opened by the grip-portion opening portion 120, the stiff finger slides on the outer surface of the grip portion 110 rather than being stretched, so the stiff finger may not be properly stretched. The pressing portion 130 causes the user's hand 10 or the user's fingers to come into close contact with the grip portion 110, thus enabling the stiff finger to be effectively stretched while the grip portion 110 is opened by the grip-portion opening portion 120.

As shown in the drawing, the grip portion 110 may include a first grip portion 112 contacting some of the user's fingers, and a second grip portion 114 contacting other fingers. The grip-portion opening portion 120 may move the first grip portion 112 and the second grip portion 114 relative to each other to stretch some of the user's fingers or other fingers. To be more specific, the first grip portion 112 and the second grip portion 114 are moved relative to each other through the grip-portion opening portion 120 in a state where the first grip portion 112 and the second grip portion 114 are held by the user's hand 10, thus adjusting a relative distance between the first grip portion 112 and the second grip portion 114, spreading the user's hand 10 that holds the grip portion 110, and thereby stretching the user's hand 10 or the user's fingers. The drawing represents a case where the user's thumb and fingers other than the thumb contact the second grip portion 114 and the first grip portion 112, respectively, as an example.

As illustrated in the drawing, a first side of each of the first grip portion 112 and the second grip portion 114 may be provided to face the user's palm. A second side of each of the first grip portion 112 and the second grip portion 114 may be provided to face the outside of the user's palm. The grip-portion opening portion 120 may adjust a distance between the first grip portion 112 and the second grip portion 114 such that a distance between the second side of the first grip portion 112 and the second side of the second grip portion 114 is larger than a distance between the first side of the first grip portion 112 and the first side of the second grip portion 114. Thereby, according to the present disclosure, the user's hand 10 holding the grip portion 110 may be opened, thus allowing the user's hand 10 or the user's fingers to be stretched.

Unlike the drawings, the grip portion 110 may further include at least one additional sub-grip portion (not shown) that is different from the first grip portion 112 and the second grip portion 114. The user's fingers may be appropriately distributed to and contact the first grip portion 112, the second grip portion 114, and the at least one additional sub-grip portion. In this case, the grip-portion opening portion 120 may move the first grip portion 112, the second grip portion 114, and the at least one additional sub-grip portion relative to each other to stretch the user's fingers that are in contact with the first grip portion 112, the second grip portion 114, and the at least one additional sub-grip portion, respectively. Hereinafter, for the convenience of description, the upper limb rehabilitation device 100 of the present disclosure will be described using the grip portion 110 including the first grip portion 112 and the second grip portion 114. It is apparent that this description is not intended to limit the scope of the present disclosure.

As illustrated in the drawing, some of the user's fingers may contact the outer surface of the first grip portion 112, while other fingers may contact the outer surface of the second grip portion 114.

The grip-portion opening portion 120 may include a rotating portion 121 that is rotatable, a support portion 122 that supports the rotating portion 121 such that it is rotatable at a fixed position, and a moving portion 123 that moves rectilinearly above the rotating portion 121 when the rotating portion 121 rotates. At least any one of the first grip portion 112 and the second grip portion 114 may be connected to the support portion 122 and the moving portion 123. At least any one of the first grip portion 112 and the second grip portion 114 may be opened or closed by the rectilinear movement of the moving portion 123. The grip-portion opening portion 120 may further include a rotating-portion guide portion 121a to allow the rotating portion 121 to be stably rotated while being supported on the support portion 122. A through hole through which the rotating portion 121 passes may be formed in the rotating-portion guide portion 121a. A bearing may be provided in the through hole of the rotating-portion guide portion 121a to contact the outer surface of the rotating portion 121 and allow the outer surface of the rotating portion 121 to be freely rotated.

The operation of the grip-portion opening portion 120 acting on the grip portion 110 will be described in detail with reference to FIGS. 2 to 4.

As shown in FIGS. 2 and 3, some of the user's fingers may contact the outer surface of the first grip portion 112, while other fingers may contact the outer surface of the second grip portion 114.

As shown in FIG. 4, the grip-portion opening portion 120 may include a rotating portion 121, a support portion 122, and a moving portion 123. The grip-portion opening portion 120 may optionally include a rotating-portion guide portion 121a, a rotary handle 121b, a first connecting portion 124, a second connecting portion 125, a third connecting portion 126, and a fourth connecting portion 127.

The rotating portion 121 may have a thread on an outer surface thereof, and may be rotatable. For example, the rotating portion 121 may be a rotating shaft having a thread on the outer surface thereof.

The support portion 122 may support the rotating portion 121 to rotate while maintaining its position. The support portion 122 may include, for example, a support plate having a depression into which a first end of the rotating portion 121 may be inserted, and a bearing provided to be inserted into the depression of the support plate. The bearing of the support portion 122 may be coupled to the first end of the rotating portion 121. The first end of the rotating portion 121 may be rotated while being inserted into the depression of the support portion 122 through the bearing of the support portion 122. Thereby, the support portion 122 may support the rotating portion 121 to rotate while maintaining its position. For instance, the support portion 122 may be provided to be secured to the prop portion 140 that will be described later.

The moving portion 123 may be provided with a through hole through which the rotating portion 121 passes, and the moving portion 123 may be coupled in a thread fastening method to the rotating portion 121 via the through hole of the moving portion 123. That is, a thread (hereinafter, referred to as a second thread) having a shape corresponding to that of the thread (hereinafter, referred to as a first thread) provided on the outer surface of the rotating portion 121 may be provided on the inner surface of the through hole of the moving portion 123. By coupling the first thread of the rotating portion 121 and the second thread of the through hole, the moving portion 123 may be fastened to the rotating portion 121.

The first connecting portion 124 may connect the inner surface of the first grip portion 112 and the support portion 122. In this case, the first connecting portion 124 may be rotatably provided on the support portion 122.

The second connecting portion 125 may connect the inner surface of the first grip portion 112 and the moving portion 123. In this case, the second connecting portion 125 may be provided to be rotatable with the inner surface of the first grip portion 112 and the moving portion 123, respectively.

The third connecting portion 126 may connect the inner surface of the second grip portion 114 and the support portion 122. In this case, the third connecting portion 126 may be rotatably provided on the support portion 122.

The fourth connecting portion 127 may connect the inner surface of the second grip portion 114 and the moving portion 123. In this case, the fourth connecting portion 127 may be provided to be rotatable with the inner surface of the second grip portion 114 and the moving portion 123, respectively.

The rotating-portion guide portion 121a may guide the rotating portion 121 to allow the rotation portion to be stably rotated while being supported by the support portion 122. For instance, the rotating-portion guide portion 121a may be provided to be secured to the prop portion 140 that will be described later.

The rotary handle 121b may be provided on a second end of the rotating portion 121. The operator 30 may rotate the rotating portion 121 through the rotary handle 121b.

If the operator 30 rotates the rotating portion 121 directly or through the rotary handle 121b, the rotating portion 121 may rotate while its position is maintained by the support portion 122. The moving portion 123, which is provided to be rotatable with the inner surface of the inner surface of the first grip portion 112 and the inner surface of the second grip portion 114 through the second connecting portion 125 and the fourth connecting portion 127, is moved above the rotating portion 121 while the rotating portion 121 is rotating. The moving portion 123 may move towards or away from the support portion 122 depending on the rotating direction of the rotating portion 121. In this case, each of the first connecting portion 124 and the third connecting portion 126 is rotatably provided on the support portion 122, thus allowing the moving portion 123 to move above the rotating portion 121 while the rotating portion 121 is rotating.

When the moving portion 123 moves towards the support portion 122 by the rotation of the rotating portion 121, the second connecting portion 125 provided to be rotatable with the inner surface of the first grip portion 112 and the moving portion 123 pushes the inner surface of the first grip portion 112. The fourth connecting portion 127 provided to be rotatable with the inner surface of the second grip portion 114 and the moving portion 123 pushes the inner surface of the second grip portion 112. Thereby, the grip-portion opening portion 120 according to the present disclosure may operate the grip portion 110 to open the grip portion 110.

When the moving portion 123 moves away from the support portion 122 by the rotation of the rotating portion 121, the second connecting portion 125 provided to be rotatable with the inner surface of the first grip portion 112 and the moving portion 123 pulls the inner surface of the first grip portion 112. The fourth connecting portion 127 provided to be rotatable with the inner surface of the second grip portion 114 and the moving portion 123 pulls the inner surface of the second grip portion 112. Thereby, the grip-portion opening portion 120 according to the present disclosure may operate the grip portion 110 to close the grip portion 110.

In order to cause the grip-portion opening portion 120 to effectively open or close the grip portion 110, the length of the second connecting portion 125 and the length of the fourth connecting portion 127 may be preferably longer than the length of the first connecting portion 124 and the length of the third connecting portion 126, respectively.

Although a case where the length of the second connecting portion 125 and the length of the fourth connecting portion 127 are equal to each other is illustrated in the drawing, the length of the second connecting portion 125 and the length of the fourth connecting portion 127 may be different from each other.

Referring to FIGS. 3 and 4, in the case that the length of the fourth connecting portion 127 is longer than the length of the second connecting portion 125, when the moving portion 123 moves towards the support portion 122 by the rotation of the rotating portion 121, the second grip portion 114 is opened to be relatively more than the first grip portion 112. Thereby, among the fingers of the user's hand 10, the thumb may be stretched more than other fingers.

In contrast, in the case that the length of the second connecting portion 125 is longer than the length of the fourth connecting portion 127, when the moving portion 123 moves towards the support portion 122 by the rotation of the rotating portion 121, the first grip portion 112 is opened to be relatively more than the second grip portion 114. Thereby, among the fingers of the user's hand 10, fingers other than the thumb may be stretched more than the thumb.

The grip portion 110 and the grip-portion opening portion 120 may be seated on the prop portion 140. For instance, the support portion 122 and the rotating-portion guide portion 121a may be fixedly provided on the prop portion 140. The grip-portion opening portion 120 may be seated on the prop portion 140 through the support portion 122 or the rotating-portion guide portion 121a, which are fixedly provided on the prop portion 140. The grip portion 110 may be seated on the prop portion 140 through the first connecting portion 124 and the third connecting portion 126 connected to the support portion 122.

The arm support portion 150 may support the user's arm 20. As illustrated in FIG. 5, the arm support portion 150 may include an arm fixing portion 152 for fixing the user's arm 20 seated on the arm support portion 150. Although the arm fixing portion 152 of a Velcro type is illustrated as an example, the present disclosure is not limited thereto. Further, as illustrated in the drawing, the arm support portion 150 may include an arm removal preventing portion 154 that protrudes to support both sides of the user's arm 20 and may thereby prevent the user's arm 20 from being removed. Meanwhile, although not shown in the drawings, an insert body may be further provided to be inserted into a gap between the user's arm 20 seated on the arm support portion 150 and the arm removal preventing portion 154 and may thereby stably maintain the user's arm 20 seated on the arm support portion 150.

The prop portion 140 may be connected at a first side thereof to the arm support portion 150. In this case, the first side of the prop portion 140 may be rotatably connected to the arm support portion 150. The prop portion 140 may be rotatably connected to the arm support portion 150 through a shaft passing through the first side of the prop portion 140 and a corresponding portion of the arm support portion 150 that is opposite to the first side of the prop portion 140, but the present disclosure is not limited thereto.

The fixing portion 160 may fix the prop portion 140 that rotates relative to the arm support portion 150.

The fixing portion 160 may be provided under the prop portion 140, and may include a fixing plate 162 that is secured at a first side thereof to the arm support portion 150 and an arm-rotation-angle maintaining portion 164 that is secured to the fixing plate 162 to prevent the movement of the prop portion 140 that has rotated relative to the arm support portion 150. In order to stably rotate the prop portion 140, the fixing plate 162 and the prop portion 140 may be preferably spaced apart from each other by a predetermined distance. On the other hand, the fixing portion 160 may include a fixing plate prop portion 162b to stably place the fixing plate 162 on a bottom surface.

For instance, as illustrated in the drawing, the second side of the fixing plate 162 may be provided in the shape of an arc, and a plurality of depressions 162a may be provided along the circumference of the second side of the fixing plate 162. The arm-rotation-angle maintaining portion 164 may be provided on the second side of the prop portion 140. In this case, the arm-rotation-angle maintaining portion 164 may be fastened to any one of the plurality of depressions 162a to fix the rotating position of the prop portion 140 that has rotated relative to the arm support portion 150. For example, the arm-rotation-angle maintaining portion 164 may include a rotary plate that is rotatably provided on the second side of the prop portion 140, and a protrusion that is provided on the rotary plate to protrude therefrom. By fitting the protrusion into any one of the plurality of depressions 162a, the rotating position of the prop portion 140 that has rotated relative to the arm support portion 150 may be fixed.

Hereinafter, the operation of the prop portion 140, the arm support portion 150, and the fixing portion 160 will be described with reference to FIGS. 2, 5, 6, and 7. Further, the related operation of the grip portion 110, the grip-portion opening portion 120, the prop portion 140, the arm support portion 150, and the fixing portion 160 will be described below.

As illustrated in FIG. 2, the user who uses the upper limb rehabilitation device 100 according to the present disclosure may hold the grip portion 110 with the user's hand 10. Subsequently, as illustrated in FIG. 5, the user may rotate the prop portion 140 relative to the arm support portion 150 while holding the grip portion 110 with the user's hand 10. As illustrated in FIG. 6, the prop portion 140 that has rotated relative to the arm support portion 150 may fasten the arm-rotation-angle maintaining portion 164 to any one of the plurality of depressions 162a, thus fixing the arm-rotation-angle maintaining portion to the depression. Thereby, the upper limb rehabilitation device 100 according to the present disclosure may stretch the user's arm 20 and the user's wrist.

As illustrated in FIG. 7, the user may open the grip portion 110 through the grip-portion opening portion 120 after rotating the prop portion 140 relative to the arm support portion 150 while holding the grip portion 110 with the user's hand 10. Thereby, the upper limb rehabilitation device 100 according to the present disclosure may simultaneously stretch the user's hand 10 or the user's fingers in a state where the user's arm 20 and the user's wrist are stretched.

In summary, the present disclosure includes the grip portion 110 that may be held by the hand of a user, i.e., a patient, and the grip-portion opening portion 120 that may open or close the grip portion 110. The user, the user's caregiver, or the rehabilitation therapist may stretch the user's hand 10 or the user's fingers, which hold the grip portion 110, by operating the grip-portion opening portion 120, may adjust the degree of opening or closing the grip portion 110 through the grip-portion opening portion 120, and then may fix the grip portion, thus allowing the user's hand 10 or the user's fingers to be precisely stretched.

Further, the present disclosure allows the user's hand 10 or the user's fingers, positioned between the grip portion 110 and the pressing portion 130 through the pressing portion 130 provided to be spaced apart from the grip portion 110, to stably come into close contact with the grip portion 110, thus allowing the user's hand 10 or the user's fingers to be stably stretched while the grip portion 110 is opened by the grip-portion opening portion 120.

Furthermore, the present disclosure may include the prop portion 140 on which the grip portion 110 and the grip-portion opening portion 120 are seated, and the arm support portion 150 to which the prop portion 140 is rotatably connected and which supports the user's arm 20. The user may hold the grip portion 110 with the user's hand 10 in a state where the user's arm 20 is supported on the arm support portion 150. Thereafter, the user may rotate the prop portion 140 relative to the arm support portion 150, thus enabling the user's arm 20 and the user's wrist to be stretched. In this case, the present disclosure may further include the fixing portion 160 for fixing the prop portion 140 that has rotated relative to the arm support portion 150, thus fixing the prop portion 140 that has rotated relative to the arm support portion 150, and thereby allowing the user's arm 20 and the user's wrist to be precisely stretched.

In a state where the user's arm 20 is supported by the arm support portion 150, the user's hand 10 holds the grip portion 110, and the user's arm 20 is rotated through the rotation of the prop portion 140 relative to the arm support portion 150, the grip portion 110 may be opened through the grip-portion opening portion 120. Thereby, the present disclosure may simultaneously stretch the user's arm 20, the user's wrist, the user's hand 10, and the user's fingers. The muscle of the user's hand 10 or the user's fingers extends to the user's arm 20 and the user's wrist. The upper limb rehabilitation device 100 according to the present disclosure may simultaneously stretch the user's hand 10 or the user's fingers in a state where the user's arm 20 and the user's wrist are stretched, thus providing a stretching effect different from effect achieved by individually stretching the user's arm 20, the user's wrist, the user's hand 10 or the user's fingers.

Although the present disclosure was described with reference to specific embodiments shown in the drawings, it is apparent to those skilled in the art that the present disclosure may be changed and modified in various ways without departing from the scope of the present disclosure, which is described in the following claims.

What is claimed is:

1. An upper limb rehabilitation device comprising:
a grip portion provided to be held by a user's hand; and
a grip-portion opening portion operating the grip portion to open or close the grip portion.

2. The upper limb rehabilitation device of claim 1, further comprising:
a pressing portion provided to be spaced apart from the grip portion,
wherein the pressing portion causes the user's hand positioned between the grip portion and the pressing portion to come into close contact with the grip portion.

3. The upper limb rehabilitation device of claim 1, wherein the grip portion comprises a first grip portion contacting some of the user's fingers, and a second grip portion contacting other fingers of the user, and
the grip-portion opening portion moves the first grip portion and the second grip portion relative to each other to stretch some of the user's fingers or other fingers.

4. The upper limb rehabilitation device of claim 3, wherein a first side of each of the first grip portion and the second grip portion is provided to face the user's palm, and a second side of each of the first grip portion and the second grip portion is provided to face an outside of the user's palm, and
the grip-portion opening portion adjusts a distance between the first grip portion and the second grip portion such that a distance between the second side of the first grip portion and the second side of the second grip portion is larger than a distance between the first side of the first grip portion and the first side of the second grip portion.

5. The upper limb rehabilitation device of claim 3, wherein some of the user's fingers contact an outer surface of the first grip portion, while other fingers contact an outer surface of the second grip portion, and
wherein the grip-portion opening portion comprises:
a rotating portion that is rotatable;
a support portion configured to support the rotating portion such that it is rotatable at a fixed position; and
a moving portion configured to move rectilinearly above the rotating portion when the rotating portion rotates, and
wherein at least any one of the first grip portion and the second grip portion is connected to the support portion and the moving portion, and
at least any one of the first grip portion and the second grip portion is opened or closed by the rectilinear movement of the moving portion.

6. The upper limb rehabilitation device of claim 3, wherein some of the user's fingers contact an outer surface of the first grip portion, while other fingers contact an outer surface of the second grip portion, and
wherein the grip-portion opening portion comprises:
a rotating portion that has a thread on an outer surface thereof and is rotatable;
a support portion fixedly supporting the rotating portion so that the rotating portion is rotatable;
a moving portion having a through hole through which the rotating portion passes, and coupled in a thread fastening method to the rotating portion;
a first connecting portion connecting an inner surface of the first grip portion and the support portion, and rotatably provided on the support portion;
a second connecting portion connecting the inner surface of the first grip portion and the moving portion, and provided to be rotatable with the inner surface of the first grip portion and the moving portion, respectively;
a third connecting portion connecting an inner surface of the second grip portion and the support portion, and rotatably provided on the support portion; and
a fourth connecting portion connecting the inner surface of the second grip portion and the moving portion, and provided to be rotatable with the inner surface of the second grip portion and the moving portion, respectively.

7. The upper limb rehabilitation device of claim 1, further comprising:
a prop portion on which the grip portion and the grip-portion opening portion are seated; and
an arm support portion configured to support a user's arm,
wherein the prop portion is connected at a first side thereof to the arm support portion, and the first side of the prop portion is rotatably connected to the arm support portion.

8. The upper limb rehabilitation device of claim 7, further comprising:
a fixing portion configured to fix the prop portion that has rotated relative to the arm support portion.

9. The upper limb rehabilitation device of claim 8, wherein the fixing portion comprises:
a fixing plate provided under the prop portion, and secured at a first side thereof to the arm support portion; and
an arm-rotation-angle maintaining portion secured to the fixing plate to prevent a movement of the prop portion that has rotated relative to the arm support portion.

10. The upper limb rehabilitation device of claim 9, wherein a second side of the fixing plate is provided in a shape of an arc, and a plurality of depressions is provided along a circumference of the second side of the fixing plate,
the arm-rotation-angle maintaining portion is provided on a second side of the prop portion, and
the arm-rotation-angle maintaining portion is fastened to any one of the plurality of depressions to fix a rotating position of the prop portion that has rotated relative to the arm support portion.

11. The upper limb rehabilitation device of claim 10, wherein the grip portion comprises a first grip portion contacting some of the user's fingers, and a second grip portion contacting other fingers of the user, and
the grip-portion opening portion moves the first grip portion and the second grip portion relative to each other to stretch some of the user's fingers or other fingers.
